(19) United States
(12) Patent Application Publication
(10) Pub. No.: US 2016/0148012 A1
(43) Pub. Date: May 26, 2016

(54) SYSTEM, METHOD AND APPARATUS FOR VOICE BIOMETRIC AND INTERACTIVE AUTHENTICATION

(71) Applicant: SpeechPro, Inc., New York, NY (US)

(72) Inventors: Alexey Khitrov, New York, NY (US); Oleg Kovak, Saint-Petersburg (RU)

(73) Assignee: SPEECHPRO, INC., New York, NY (US)

(21) Appl. No.: 14/946,677

(22) Filed: Nov. 19, 2015

Related U.S. Application Data
(60) Provisional application No. 62/081,658, filed on Nov. 19, 2014.

(51) Int. Cl. G06F 21/62; G06F 3/16; G06F 3/0488; G06F 21/32; G06F 3/0481

(52) U.S. Cl. CPC G06F 21/6218; G06F 21/32; G06F 3/04817; G06F 3/04883; G06F 3/167

(57) ABSTRACT

A system, method and apparatus is disclosed for voice biometric and interactive authentication including the obtaining of a voice authentication file and a sequence of user's face images and making a decision about the presence of a dummy on the images. A distinctive feature of invention combine pronunciation of a phrase (in addition to physically typing in) taken from this grid with the voice biometrics that will double check not only if the voice is correct, but if the numbers are correct as well. This passphrase is secured during pronunciation because the numbers are changing randomly and frequently while the same numbers are also placed in the other places along the selected graphic, grid, pattern or a combination thereof.

### CROSS-REFERENCE TO RELATED APPLICATION

This application relates to and takes priority from U.S. Provisional Patent Application Ser. No. 62/081,658 filed on Nov. 19, 2014 and entitled “SYSTEM, METHOD AND APPARATUS FOR VOICE BIOMETRIC AND INTERACTIVE AUTHENTICATION” which application is incorporated by reference in its entirety.

### BACKGROUND OF THE INVENTION

1. Field of the Present Invention

The present invention relates generally to biometric authentication, in particular, to a system method and apparatus for bimodal user verification by face and voice, and can be used in the systems intended for prevention of unauthorized access to premises or information resources.

2. Background of the Related Art

Biometric identification is the process of automatic identity confirmation based on the individual information contained, in particular, into audio signals and face images. This process might be divided to identification and verification. Thus the identification procedure detects which one of the presented speakers exactly talks, and the verification procedure consists in determining of match or mismatch of the speaker's identity. Verification can be used to control access to the restricted services, such as telephone access to banking transactions, shopping or access to secret equipment.

Usually a usage of this technology consists in pronouncing of a short phrase to the microphone by the user and potentially making a photo of his face. After that some acoustic characteristics (sounds, frequencies, pitches, and other physical characteristics of the voice channels that are commonly referred to as sound characteristics) and individual facial traits (the positions of nose, eyes, corners of the mouth, etc.) are determined and measured. Then these characteristics are utilized to determine a set of unique audio and video parameters of the user (so-called “voice model” and “facial model”). Usually this procedure is called registration. In this case a registration is the obtaining of a voice sample and a face image. Voice and facial models are stored with the personal identifiers and used in security protocols. During the verification procedure the user is ordered to repeat the phrase used for his registration and possibly to make a photo of his face. The voice verification algorithm realizes the comparison of user's voice with the voice sample made during the registration procedure; and the face verification algorithm realizes the comparison of user's face with the face image made during the registration procedure. Then the verification technology accepts or rejects the user's attempt to map over the voice and facial samples. If the samples are matched, the user is given a secure access. Otherwise the secure access will be denied for this user.

Usage of the voice biometrics for authentication may be threatened by the possibility of a “replay attack”. A replay attack can be carried out if a voice is recorded by a fraudster during a usual authentication process and replayed when trying to break in the system. To reduce the possibility of the replay attack vendors are using so called dynamic password, which usually consists of a random number sequence that a user is prompted to say. However if a fraudster possess a recording with a full list of numbers from zero to nine it is easy to spoof a dynamic passphrase too. However if a fraudster doesn't know which numbers to replay this kind of attack may be very hard to carry out. This invention proposes to combine a visual secret pattern (what you know) and a voice biometrics (what you are) in order to achieve better security.

Different vendors are trying to use different approaches. Some of them accepting the risk of replay attack, some of them are using dynamic password (e.g. number sequence), some of them were even trying to use the text-independent voice biometrics algorithms with an open dictionary.

Unfortunately none of the existing approaches are secure enough, because they all are focused on answering the question “What you are”. If this factor is successfully spoofed by a potential fraudster, than it gives him a possibility to break in the system. Additionally current state of the art biometric systems do not recognize identical tweens or a synthesized speech in most cases.

One of the voice biometrics methods that could reduce the possibility of fraud is based on a dynamic password (a random number sequence). A user is prompted so say a unique passphrase, generated automatically during an authentication session. Dynamic passphrases are different with each iteration thereby making it difficult to record one utterance and create a replay attack based on it. However there is exists the possibility that fraudsters may possess a recording with a full number sequence from 0 to 9, hence making it possible to carry out a replay attack. As such that only way to prevent this kind of attack is to add another layer of security. If a user does not know what numbers to replay, he will never succeed.

Another method of authentication includes visual assisted passphrase. Possible iterations of this feature include a picture with a visual interface, with a series of numbers generated randomly. Optimally only the user knows which of series of numbers and pictures is correct and in which sequence. Such a system has been disclosed in European Patent Number EP1964078 B. Another system has been disclosed in U.S. Published Patent Application US20140115670 A1.

However a continued drawback to these systems is the possibility of fraudsters collecting personal information can possibly attack the security of this system. The continued drawback to the independent systems described above is that they are each susceptible to attack by a fraudster obtaining personal information without the knowledge of the user.

### OBJECTS OF THE INVENTION

An object of the invention is to create an authentication system that can defeat unauthorized access unauthorized users even in the event such fraudsters learns of passwords and/or obtains a voice recording of the user.

Another object of the invention to combine pronunciation of a phrase (instead of typing in) taken from a visual presentation of a passcode grid with a user's voice biometrics that will double check not only if the voice is correct, but if the numbers are correct as well.

Another object of the invention is to create an authentication system where a passphrase is cannot be compromised during pronunciation because the numbers are changing every minute and the same numbers are also placed in the other places.

Another object of the invention is to employ two factors: 1)“What you know” and 2) “What you are” in a single solution elevates the security of each factor in combination.

### SUMMARY OF THE INVENTION

The present invention includes a system, method and apparatus for voice biometric and interactive authentication. Usage of a secret visual pattern used as a one-time password may improve the capabilities of the voice biometrics and reduce the possibility of a replay attack.

Consequently during the utterance of a passphrase in combination with a series of unique patterns, grids, graphics or symbols plus an estimation of the user's facial expressions is statistically predictable and allows the system to apply an analysis of user authentication.

In a first embodiment, the present invention includes a method having the following steps presented in the following sequence of actions:

1. User enrolls his unique pattern on a grid (or in any other visual).

2. When user is going to authenticate, the user can see a grid and will pronounce the presented series of numbers or symbols from the same places and in the same sequence.

In a first aspect the invention includes A method for securing access to a device, the method including the steps of collecting an authenticated voice biometric file for a user; during a bimodal authentication when a user pronounces a passphrase, collecting a plurality of photos of the user's face over a set of equal time periods; providing at least one of a pattern, grid, graphic and a series of symbols; and performing an authorization test to determine the user's access to the secure area.

In some embodiments the symbols include at least one of alphanumeric characters, emoticons, icons, drawings, figures, graphics, punctuation and mathematical characters.

In some embodiments the a voice biometric file is collected using an enrollment process having the following steps, prompting the user to utter at least on the series of symbols, recording said utterance in a data storage file and securing said data storage file with a unique identifier known only to the user.

In a second aspect the present invention includes a security application for a mobile electronic device having a series of structured and arranged security arrays displayed on a GUI on the electronic device, where such arrays are capable of being manipulated by a user to enroll the user in the security application by responding to the user's touch upon the GUI, the security application further comprising the ability to capture the user's photo and determining the liveness of the user, and the security application capable of capturing the user's voice in order to enroll the user in the security application.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a block diagram showing an exemplary computing environment in which aspects of the present invention may be implemented;

FIG. 2 shows an exemplary unique grid pattern for the enrollment procedure according to one embodiment of the present invention;

FIG. 3 shows an exemplary GUI with the unique grid pattern and images according to an authenticate procedure and/or access procedure according one embodiment of the present invention;

FIG. 4 shows another exemplary GUI with the unique grid pattern and images to an authenticate and/or access procedure according one embodiment of the present invention;

FIG. 5 shows a mobile device enrollment procedure according one embodiment of the present invention;

FIG. 6 shows another view of the mobile device enrollment procedure according in FIG. 5 according to one embodiment of the present invention; and

FIG. 7 shows another view of the mobile device enrollment procedure according in FIG. 5 and according to one embodiment of the present invention.

### DETAILED DESCRIPTION OF THE PREFERRED EMBODIMENTS

The present disclosure will now be described more fully with reference to the Figures in which an embodiment of the present disclosure is shown. The subject matter of this disclosure may, however, be embodied in many different forms and should not be construed as being limited to the embodiments set forth herein.

Exemplary Operating Environment

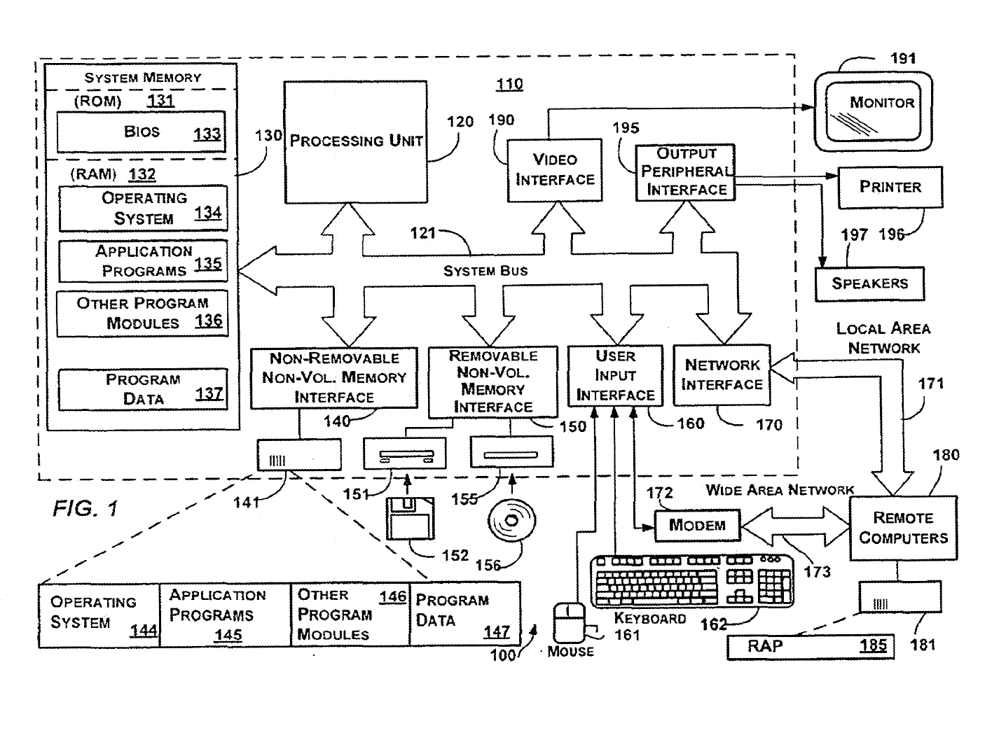

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

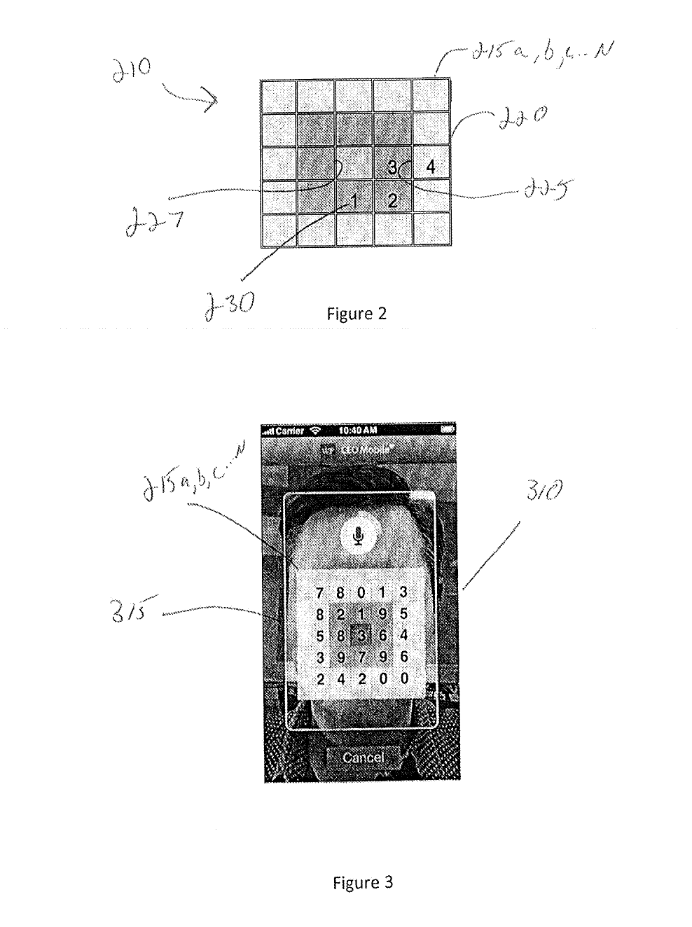

Referring now to FIG. 2 the present invention is shown according to a preferred embodiment which includes a unique grid pattern 210 used in an enrollment procedure. Pattern 210 can include a series of color coded boxes 215, a, b, up to n. A series of color coded boxes can be in nested boxes 220, 225 and 227. Within each box there can be a reference, such as a numerical reference as in the numbers 1, 2, 3, 4 as shown in boxes 230. Other reference icons such as letters, designed emojis are possible as well. During the voice recording process some full-face user's photos/images may be used (see FIG. 3). A first photo is taken at the initial time of the passphrase recording and the other ones are taken in certain time periods (typically no longer than 1 second).

Referring now to FIG. 3 the present invention is shown according to a preferred embodiment which includes an authentication procedure using grid pattern 210 having boxes 215, a, b through n. A photo grid pattern 310 having a photo 315 is presented to the user who the inputs a series of vocal entries in a same places and sequences as the unique and dynamic pattern is displayed. The system authenticates the user's voice such that each time a new and unique dynamic series of numbers and/or symbols are presented via boxes 215 such that the user's vocal patterns can be recognized and being unique to the user. The user can also touch or swipe the passcode along with

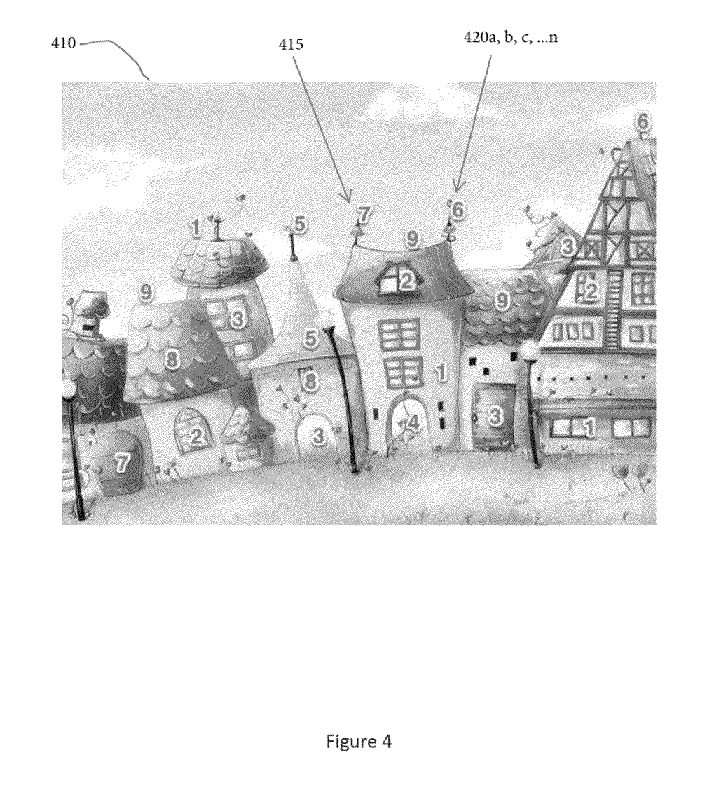

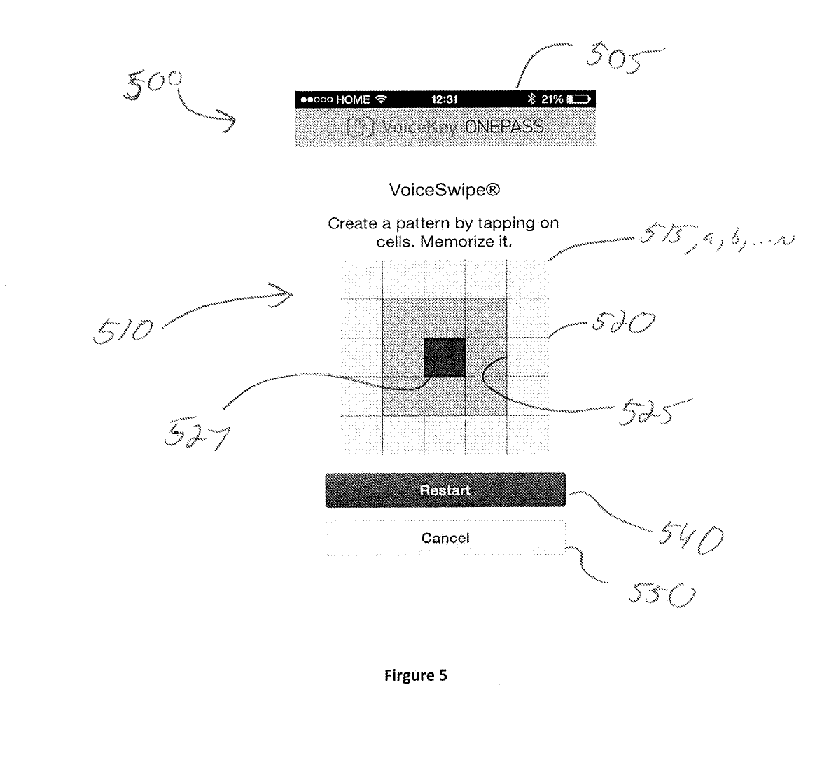

Referring now to FIG. 4 there is shown an alternative pattern and grid 410. A random visual graphic pattern 415, in this case a series of odd shaped houses, with reference numbers 420 a, b, c . . . n randomly placed over the pattern 415. The user may use this interface to input a series of numbers and patterns as desired so that a random presentation of the graphic combined with dynamically changing placement of numbers and/or other symbols can be utilized by the user to gain access. The user will only have knowledge of the combination of numbers, symbols and/or pattern such that even the best fraudsters attempt to defeat the security system is thwarted. Even if a fraudster gains access to the user's information, each unique and dynamic presentation of the graphic, pattern, numbers and/or symbols is secure.

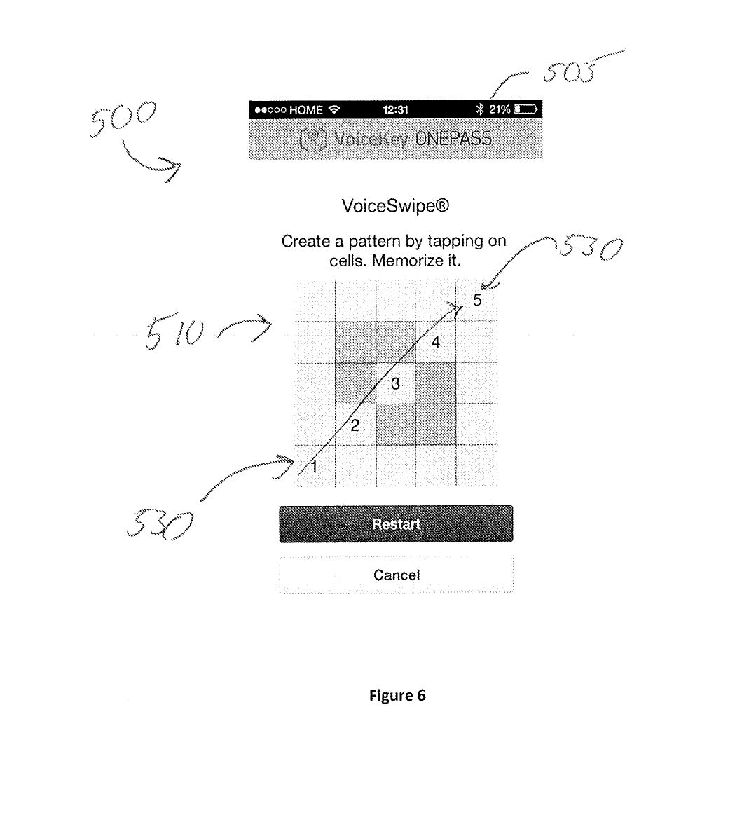

Referring now to FIGS. 5-7 there is shown another enrollment process 510 on a mobile device according to one embodiment of the present invention. FIG. 5 shows a unique grid pattern 510 used in an enrollment procedure 500. Pattern 510 can include a series of color coded boxes 515, a, b, up to n. A series of color coded boxes can be in nested boxes 520, 525 and 527. The As shown in FIG. 6 the user can either tap or swipe in several boxes. The number of tapped or swiped boxes can also be part of the enrollment and passcode secrecy. In this example the user swipes or taps from the lower left up and to the right in motion 530 creating the passcode, 1, 2, 3, 4, 5.

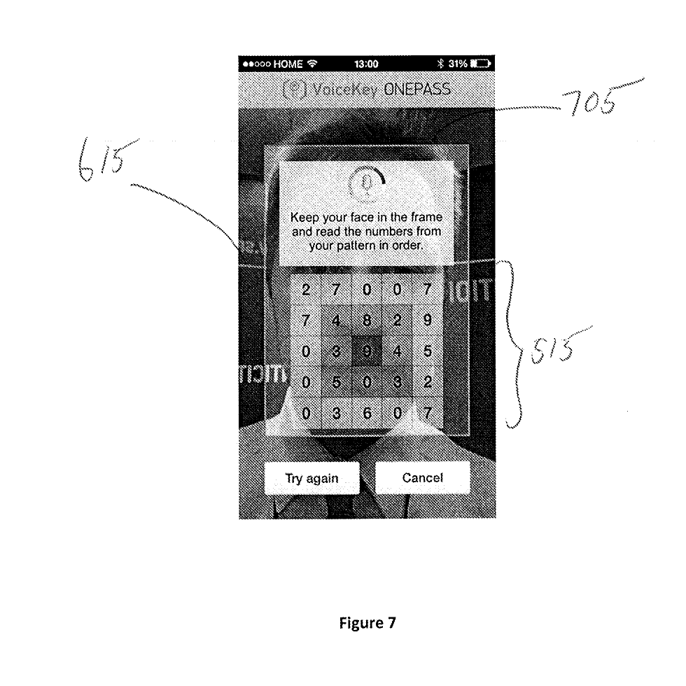

FIG. 7 shows a frame of the user face 615 along with grid pattern 515 including randomly placed references, in this case numbers. Other reference icons such as letters, designed emojis are possible as well. During the voice recording process some full-face user's photos/images may be used. A first photo is taken at the initial time of the passphrase recording and the other ones are taken in certain time periods (typically no longer than 1 second). The user is instructed to maintain his/her face in the frame, providing a liveness detection feature, and read the numbers from the pattern, or his her chosen code, aloud. In this way if a user does not know the pattern, or the numbers, then the user cannot know passcode and access will not be granted.

The combination of the unique vocal identification for the user and the randomly presented graphic, grid, pattern, and series of dynamically changed numbers and/or symbols increases the security level dramatically. The unique pattern of passcodes is authenticated via voice biometrics in combination with a GUI showing the user a pattern in multiple variations of cells and combinations.

Additionally, images of the user can also be added to the security system. An apparatus intended to realize the invention includes the interrelated data media, central processor unit and graphic interface as described in connection with FIG. 1. The data media contain the computer instructions for making an authentication voice biometric file and a few photos of the user's face simultaneously with the passphrase pronunciation along with providing the user with a series of dynamic grids, patterns or graphics and symbols to control access to secure areas or systems. This device may be implemented with using existing computer, multiprocessor and mobile based systems.

It will be apparent to one of skill in the art that described herein is a novel system, method and apparatus for voice biometric and interactive authentication. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A method for securing access to a device, the method comprising the steps of:
collecting an authenticated voice biometric file for a user;
during a bimodal authentication when a user pronounces a passphrase, collecting a plurality of photos of the user's face over a set of equal time periods;
providing at least one of a pattern, grid, graphic and a series of symbols; and
performing an authorization test to determine the user's access to the secure area.

2. The method according to claim 1 where said symbols include at least one of alphanumeric characters, emoticons, icons, drawings, figures, graphics, punctuation and mathematical characters.

3. The method according to claim 1 where said voice biometric file is collected using an enrollment process comprising the following steps:
a. prompting the user to utter at least on the series of symbols;
b. recording said utterance in a data storage file; and
c. securing said data storage file with a unique identifier known only to the user.

4. A security application for a mobile electronic device comprising the a series of structured and arranged security arrays, where such arrays are capable of being manipulated by a user to enroll said user in the security application by responding to said user's touch upon a GUI on the electronic device, the security application further comprising the ability to capture said user's photo and determining the liveness of said user, and the security application capable of capturing said user's voice in order to enroll said user in the security application.
